(19) United States
(12) Patent Application Publication
(10) Pub. No.: US 2023/0394994 A1
(43) Pub. Date: Dec. 7, 2023

(54) ROLL-UP LABEL STRIP AND LABEL FOR APPLICATION ON BAGS

(71) Applicant: Girnet Internacional, S.L., Badalona (ES)

(72) Inventors: Carles LLORENS BORRELL, Barcelona (ES); Judith DIAZ RODRÍGUEZ, Barcelona (ES)

(73) Assignee: Girnet Internacional, S.L., Badalona (ES)

(21) Appl. No.: 18/328,384

(22) Filed: Jun. 2, 2023

(30) Foreign Application Priority Data
Jun. 3, 2022 (ES) P202230482

(51) Int. Cl. G09F 3/16

(52) U.S. Cl. CPC G09F 3/16; G09F 2003/0208

(57) ABSTRACT

A roll-up strip (100, 101) of labels (10, 11) separable by a transverse cut, distinguishing on each label a main portion (2) from at least one of the longitudinal opposite ends (21, 22) of which extends a longitudinal extension (3, 4) of a smaller width than the main portion (2) and which distal end (31, 41) defines a joining area (A) attachable to a bag by application of an accessory pressing element, the strip able to be devoid of reinforcement or filler made of plastic material, and a longitudinal cut or slit (6) in each joining area (A) of the labels. The cut or slit defines two portions (61, 62) to reduce the resistance offered by the joining area to a deformation by transverse constriction to which it is subject when the accessory pressing element is applied from the outside in the bag closing operation.

### TECHNICAL FIELD OF THE INVENTION

The invention belongs to the field of consumables and in particular relates to a consumable in the form of a roll-up label strip, the labels being especially suitable for being attached to bags of fruit and vegetable products during a closing operation of the same.

### BACKGROUND OF THE INVENTION

The use of mesh tubes or tubular mesh to form bags for the packaging of fruit and vegetable products is a common practice due to the great benefits it provides, given its lightness and also its breathability and visibility which make the contained products maintain their natural properties and be shown to consumers in the most attractive way.

These bags can be closed automatically in packaging machines by applying accessory closing elements around respective tightened longitudinal portions of the bag, elements that can be in the form of a foldable metal band or any flattenable staple, in the form of a clip or other shapes. Hereinafter, reference will be made to this operation interchangeably as a stapling operation, or simply as stapling.

Conventionally, this accessory element is also used to join a label to the bag, arranging a portion of the label between the bag and the accessory element in the stapling operation. In this way, the bag is provided with a support on which information about the origin, traceability, or other characteristics of products of interest to the consumer can be printed or otherwise transferred.

The conventional material that makes up the substrate from which these labels are made is a polypropylene (PP) laminate with thermal paper or a single high-density polyethylene (HDPE) sheet. The most common thickness range for these labels is between 150 and 220 μm.

In recent years, with the aim of addressing the challenge of sustainability, new materials have been developed to replace conventional ones for this same application. Among them are bioplastic laminates such as polylactic acid (PLA), polybutylene succinate (PBS) and/or cellophane with thermal paper.

All of these foregoing solutions share a shortage of supply, a high cost and questionable performance in the functions of the label, either in terms of the tear resistance of the stapling, tensile strength of the label, or the print quality obtained by flexography or thermo-transfer.

Another aspect shared by all of the aforementioned solutions to avoid the use of conventional plastics for this application is that they increase the grammage (g/m²) and thickness (μm) of the substrate to achieve values of tensile strength and tear resistance similar to those of labels manufactured from PP laminate with thermal paper or HDPE sheet.

This fact is counterproductive in view of sustainability, since it increases the impact in terms of waste generation and CO₂ emissions during the manufacture and transport of materials mainly due to the increase in grammage of these materials compared to plastic solutions. Furthermore, increasing the thickness (μm) of the labels reduces the number of units per reel diameter, increasing the need for auxiliary materials (cores, boxes, pallets, etc.) per unit of sale at the same time that it reduces the autonomy of packaging machines at a time when process automation is increasingly important for the operation of companies.

The analysis of all these aforementioned aspects leads to the question of whether the use of these new materials developed to replace plastic labels for stapled mesh bags is a real step forward towards sustainability.

Prior to these new developments of replacement materials for plastic materials, and even prior to the use of polypropylene (PP) or high-density polyethylene (HDPE) materials that are now sought to be avoided, paper labels had been used. However, due to the rigidity shown by the area of these labels that is subjected to sudden deformation by transverse constriction to which it was forced in the stapling operation, in combination with the low tear resistance shown by the paper, an unwanted number of labels broke and the products had to be discarded.

Curiously, providing the label with a greater thickness results in a lower risk of tearing, but at the same time affects the deformation capacity offered by the label to be suddenly constrained when a staple is applied to it, which in turn leads to a greater likelihood of breakage.

FIG. 1 exemplifies this phenomenon of label deterioration, which easily leads to the tearing or breakage of the same.

Patent document U.S. Pat. No. 4,176,479, dated in 1979, discloses a proposal consisting of providing on an end joining area of a label a series of longitudinal cuts dividing the same into a plurality of strips, which are intended to be placed between a tightened longitudinal portion of a bag and a staple that is applied to it to keep this portion closed. According to U.S. Pat. No. 4,176,479, the plurality of strips makes it possible to improve the affixing of the label to the bag since, even if one strip is damaged, the label will continue to be affixed due to the other strips.

This solution is offered on a label which joining area to the bag is relatively wide, and it is not applicable to labels which joining area to the bag is formed in a narrow label portion, for example of the order of 14 mm in width, which entails that the plurality of strips formed by longitudinal cuts on this part of the label are too thin and, in the event that one of them breaks as taught by U.S. Pat. No. 4,176,479, the other strips alone do not provide enough resistance to maintain the label attached to the bag with the required certainty. Furthermore, in modern packaging machines the labels are also supplied automatically and very quickly, and the thinness of the strips causes them to lift at their ends, preventing their correct application on the bag.

On the other hand, however, it is still desirable to make these label joining areas narrow, compared to other parts of the label that are necessarily wider since they are used as a support for the printed information that must be on the label and that should be easily readable, in order to save on material.

### DESCRIPTION OF THE INVENTION

With the aim of finding an alternative to the new materials that are developed as substitutes for plastic materials, a label strip is disclosed that may be devoid of reinforcements or special fillers made of plastic material, and that, contrary to the most innovative proposals, may be entirely made of paper.

The strip has a contour that follows a repetitive pattern which defines a linear succession of labels that can be separated by a transverse cut of the strip, the labels being especially suitable for application on bags of fruit and vegetable products, such as mesh bags, distinguishing for this purpose on each label, longitudinally, a main portion, bearing information printed or otherwise transferred to the strip on at least one of its faces, and from at least one of the opposite longitudinal ends of which there extends a longitudinal extension of a smaller width than that of the main portion and which distal end defines a joining area that is intended to be used to attach the label to a previously tightened longitudinal portion of a bag and to be secured to the same by external application of an accessory pressing, clamping or bridling, element, in a bag closing operation.

In essence, the strip is characterised in that in each label joining area a longitudinal cut or slit is made in the strip which defines two portions therein, a cut or slit that will reduce the resistance offered by said joining area to a deformation by transverse constriction to which it will be subject when the accessory pressing element is applied to it from the outside, be it in the form of a foldable band or any flattenable staple, clip or similar in the bag closing operation.

Based on the fact that the materials of interest, such as those of cellulosic origin, are not able to match the properties of plastic per unit mass, efforts have been focused on reducing the rigidity of these materials of interest to prevent breaks from occurring in the aforementioned bag closing operation and in the joining areas intended to be used to attach the label to a previously tightened longitudinal portion of a bag.

The provision of the cut or slit makes the strip offer the right resistance to transverse constriction so that the joining area adapts to the shape it is forced to adopt by the application, usually sudden, of the accessory pressing element, preventing tearing even when forming two portions in the joining area entails, in theory, reducing the mechanical performance of the label.

The provision of the cut or slit to reduce the resistance offered by the label to a deformation by transverse constriction is not implemented in the main portion of the label.

The provision of the cut or slit to reduce the resistance offered by the label to a deformation by transverse constriction is not implemented in all of the longitudinal extension or extensions and is it is only implemented in the distal end of the longitudinal extension or extensions that define a joining area that is intended to be used to attach the label to a previously tightened longitudinal portion of a bag.

The proposed solution is viable against all odds for lightweight materials, since it has also been shown possible to find a balance between reducing the resistance offered by the joining area to a deformation by transverse constriction and where the ends of the two portions of the joining area do not lift when the label is supplied in an automated bag closing operation, all this despite the fact that to date the person skilled in the art has been discouraged from exploring similar solutions in view of the drawbacks that arise when directly implementing the teachings of U.S. Pat. No. 4,176,479 in narrow joining areas of unreinforced labels.

As previously mentioned, the cut or slit makes it possible to broadly increase the range of materials with potential for this label application since it significantly reduces tear resistance requirements.

Unexpectedly, it is even possible to select a market standard paper material, i.e., without reinforcements, laminates or plastic fillers or others, with a low cost, thickness less than 210 μm and grammage less than 200 g/m², meaning it can be easily rolled. This includes paper substrates or a paper complex, including its versions of thermal paper, as will be discussed and exemplified below.

Unexpectedly, it is possible to use strips which width in the joining areas is from 6 to 14 mm, preferably from 8 to 12 mm, without this width implying any widening of the extension or extensions of each label.

In one variant, all the joining areas have parallel edges and a constant width.

In one variant, the two portions into which the cut or slit divides the strip in the joining area are two equal halves.

In one variant, the cut or slit made in each joining area passes through the thickness of the strip, over the entire length of the cut or slit or in at least a portion of the same.

The cut or slit may be a continuous cut or slit.

The cut or slit may be a discontinuous or intermittent cut or slit.

The cut or slit may combine at least one through area, which passes through the thickness of the strip, with at least one non-through area, which does not pass through the thickness of the strip but marks a preferential fold line.

According to preferred embodiments of the invention, the strip is a paper strip, which is selected from a paper substrate with a grammage of 80-160 g/m² and a thickness of 100-185 μm; or a complex paper with a grammage of 100-200 g/m² and a thickness of 110-210 μm.

As previously mentioned, this paper can be a thermal paper.

The invention is applicable to labels intended to be attached to the bag by a joining area, whereby each label has a single longitudinal extension that extends to one side of the main portion; as well as to labels intended to be attached to the bag by two joining areas, whereby each label will have two longitudinal extensions, each one extending opposite to one side of the main portion.

One variant of the invention is therefore that in which a respective longitudinal extension of a smaller width than that of the main portion extends from each of the two longitudinally opposite ends of the main portion of each label, each with a corresponding distal end that defines a joining area, two consecutive labels of the strip being joined without a solution of continuity by respective joining areas, each longitudinal cut or slit being associated with a section of a common cut or slit that extends along the said two following joining areas of the strip.

In this variant, the length of the common longitudinal cut or slit that extends along the two following joining areas of the strip is preferably from 15 to 45 mm, more preferably from 20 to 40 mm.

It should be noted that the length or shape of the opposite longitudinal extensions need not be the same.

Another variant of the invention is that in which only one of the two longitudinally opposite ends of the main portion of each label extends a longitudinal extension of a smaller width than that of the said main portion, two consecutive labels of the strip being joined without a solution of continuity by the connection between the joining area of a label and the end of the main portion devoid of extension of the label that follows it on the strip, the longitudinal cut or slit extending along the joining area and also, by a smaller length, through the main portion of the label that follows it on the strip.

In this variant, the length of the longitudinal cut or slit that extends along the joining area and that extends through the main portion of the label that follows it on the strip is preferably from 5 to 40 mm, more preferably from 10 to 30 mm, remaining within the joining area by at least 80%.

Another aspect of this invention is a label that can be obtained by a transverse cut of the strip of this same invention, in which end joining area or areas the label is subdivided into two longitudinal portions that hang like a fringe from the distal end of the associated extension.

Another aspect of this invention is a mesh bag with a tightened end and closed by application of an accessory pressing element with interposition of a joining area of a label that can be obtained from a strip according to this same invention, placed so that the longitudinal extension of the main portion of the label extends coinciding with the longitudinal direction of the bag, embracing the joining area of the label at least partially to the mass of tightened mesh with the two portions of said joining area folded around the cut or slit made in this area of the label.

### BRIEF DESCRIPTION OF THE DRAWINGS

FIG. 1 shows a practical example of a deteriorated joining area on a label joined to a tightened longitudinal portion of a mesh by application of an accessory pressing element, in the form of a band folded or flattened on itself, compressing the mesh and the aforementioned label joining area;

FIG. 2 shows a practical example of a joining area of a label that can be obtained from a strip according to the invention joined to a tightened longitudinal portion of a tubular mesh by application of an accessory pressing element, in the form of a band folded or flattened on itself, compressing the mesh and the label joining area;

FIGS. 3a, 3b and 3c exemplify a first variant of the invention and show, specifically in this order, a portion of a strip that comprises a separable label of the strip, a band from which several labels of this strip can be obtained without loss of material, and a mesh bag to which a separable label of the strip has been attached by a joining area of the same using a staple that is applied to keep a previously tightened end of the bag closed; and

FIGS. 4a, 4b and 4c exemplify a second variant of the invention and show, specifically in this order, a portion of another strip that comprises a separable label of the strip, a band from which several labels of this other strip can be obtained without loss of material, and a mesh bag to which a separable label of this other strip has been attached, in this case by two joining areas of the same using staples that are applied to keep two previously tightened ends of the bag closed.

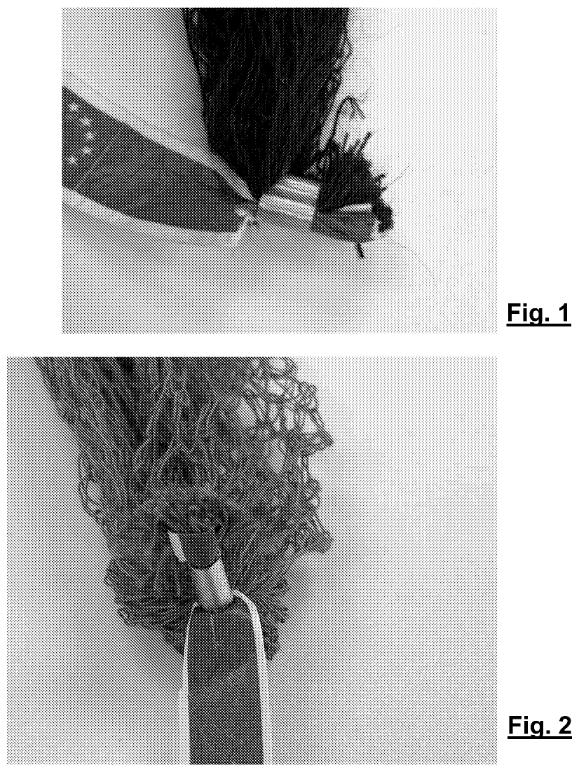

### DETAILED DESCRIPTION OF EXEMPLARY EMBODIMENTS

The invention is exemplified in two strips 100, 101 made of paper material without reinforcements or fillers made of plastic material and without reinforced paper laminates with natural fibres.

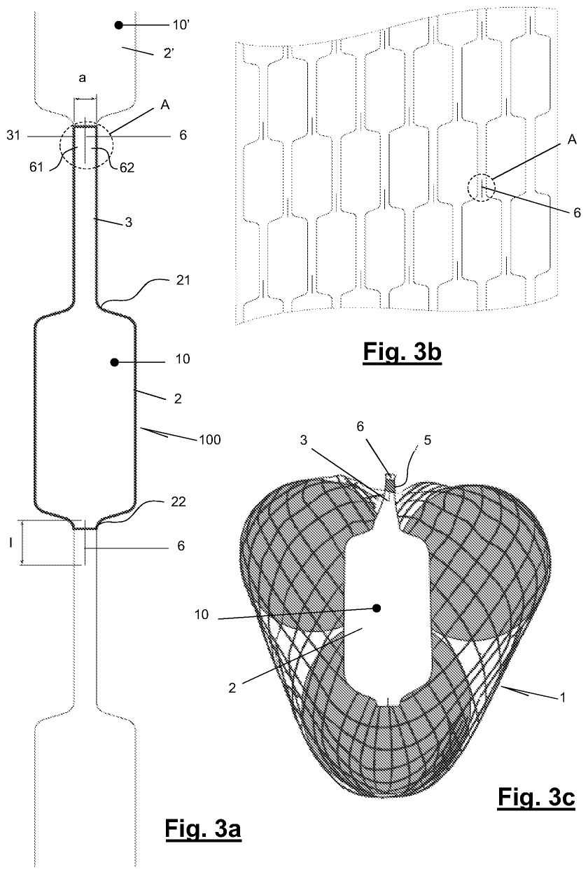

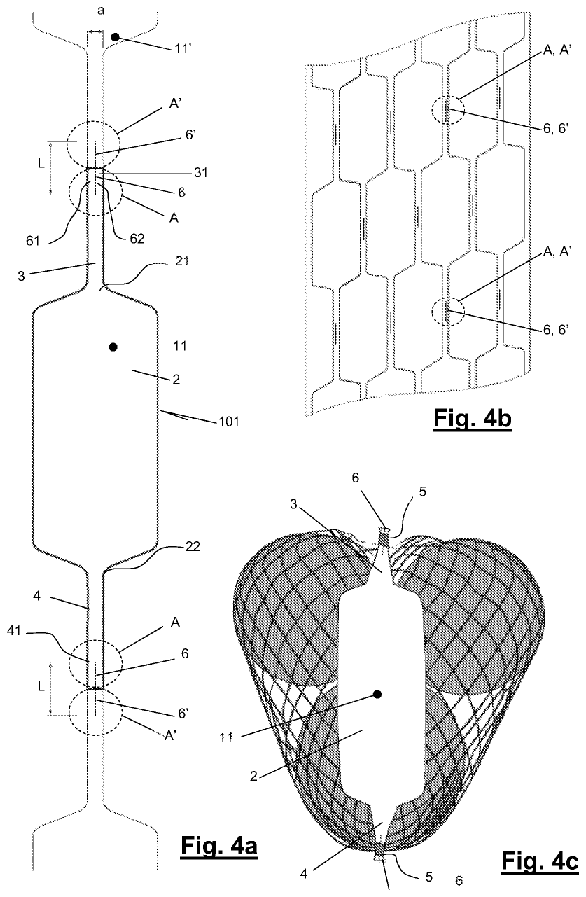

The two strips 100, 101, which are respectively represented in FIGS. 3a and 4a, have a contour that follows a repetitive pattern which defines a linear succession of labels 10 and 11, respectively, labels that can separated by a transverse cut of the strips. In these FIGS. 3a and 4a, a thicker line thickness has been used to identify a label therein.

It is common for the labels 10 and 11 to have a main portion 2 wide enough to be used as a tag and have printed information, or information otherwise transferred to the strip, of a size that can be read by a user.

For the case of the strip 101 of FIG. 4a, a respective straight, longitudinal extension 3, 4 of a smaller width than that of the main portion 2 extends from each of the two longitudinally opposite ends 21, 22 of this main portion 2 of the label 11, each extension with a corresponding distal end 31, 41 that defines a joining area A.

FIG. 4a shows how, on the strip 101, consecutive labels 11, 11′ are joined without a solution of continuity by respective joining areas A, A′.

With its two opposite joining areas A, the label 11 is designed to be attached to a bag 1, using the accessory pressing elements 5 that are applied to keep respective previously tightened ends of the same closed, as illustrated in FIG. 4c. In other words, the label 11 will be attached to the bag 1 by its joining areas A, thus connecting the areas of the bag 1 closed by the application of the aforementioned accessory elements.

For the case of the strip 100 of FIG. 3a, only one of the two longitudinally opposite ends 21, 22 of this main portion 2 of the label 10 extends a straight longitudinal extension 3 of a smaller width than that of the main portion 2, with a corresponding distal end 31 that defines a joining area A that is intended to be used to attach the label 10 to a bag 1, using an accessory pressing element 5 that is applied to keep a previously tightened end of the same closed, as illustrated in FIG. 3c. In other words, the label 10 will be attached in this case to the bag 1 by a single end, giving rise to a sort of hanging label.

FIG. 3a shows that on the strip 100 two consecutive labels 10, 10′ are joined by connection between the joining area A of a label 10 and the end of the main portion 2′ devoid of extension of the label 10′ that follows it on the strip.

Characteristically and common to both strips 100 and 101, a longitudinal cut or slit 6 is made in the strips in each joining area A of the aforementioned labels, said cut or strip which divides the joining area into two portions 61, 62, a cut or slit that will reduce the resistance offered by the said joining area A to a deformation, by transverse constriction, to which it will be subject when the accessory pressing element is applied to it in a bag closing operation.

The longitudinal cut or slit 6 extends only through the mentioned joining areas A.

In these examples, the two portions 61, 62 are equal, i.e., the cut or slit 6 is made in such a way that it subdivides the joining area A into two equal halves. This is a preferred variant of the invention.

This accessory pressing element 5 can be implemented in the form of a foldable metal band, or with a metal core, or any flattenable staple, in the form of a clip or other shapes. As previously indicated, this bag closing operation in this description interchangeably refers to a stapling operation, or simply stapling.

Although the bag is a mesh bag in the examples, the invention is applicable to bags made of any other flexible material.

FIGS. 3b and 4b have the purpose of illustrating that the object of the invention, for the case exemplified in the form of the strips 100 and 101, can be obtained without loss from an original paper band, and especially illustrating that the cuts or slits 6 can be made using one same die tool by which the contour of the various strips that can be separated is cut out on the original band, thus guaranteeing precision in the location of these cuts or slits and avoiding having to subject the strips to additional steps to finish them.

Both the strip 100 and the strip 101, or others that can be designed within the scope of the invention, can be, by way of non-limiting example, made of standard paper or thermal paper.

The technical requirements that have been shown to be optimal when using standard paper are the following:

TABLE 1
Preferred technical requirements for using standard
paper to make a strip according to the invention.

| | | Preferred | Wide | |
|---|---|---|---|---|
| Property | Unit | range | range | Standard |
| Grammage | g/m² | 100-140 | 80-160 | — |
| Thickness | μm | 140-160 | 100-185 | ISO 534 |
| Tensile strength MD | kN/m | >10 | >9 | ISO 1924/1 |
| Tensile strength CD | kN/m | >6 | >5 | ISO 1924/1 |
| Tear strength MD | cN | >1100 | >900 | ISO 1974 |
| Tear strength CD | cN | >1200 | >1000 | ISO 1974 |
| BENDTSEN | ml/min | <100 | <500 | ISO/DP 8791-2 |
| smoothness FS | | | | |
| BENDTSEN | ml/min | <500 | <700 | ISO/DP 8791-2 |
| smoothness RS | | | | |
| CIE whiteness | % | >85 | >80 | SCAN P 66 |
| D65/10° | | | | |
| Brightness 75° | % | 15-25 | 10-30 | TAPPI 480 |

A paper candidate that meets these requirements is MG Bleached Kraft paper that is calendered, water-resistant and has a grammage of 120 g/m².

Another paper candidate that meets these requirements is the commercially available paper with reference CBE MG NOB WS.

A thermal paper candidate that also meets these requirements is the commercially available paper with reference TF 8067.

The technical requirements that have been shown to be optimal when using a paper complex are the following:

TABLE 2
Preferred technical requirements for using thermal
paper to make a strip according to the invention.

| | | Preferred | Wide | |
|---|---|---|---|---|
| Property | Unit | range | range | Standard |
| Grammage | g/m² | 140-180 | 100-200 | — |
| Thickness | μm | 150-190 | 110-210 | ISO 534 |
| Tensile strength MD | kN/m | >10 | >9 | ISO 1924/1 |
| Tensile strength CD | kN/m | >6 | >5 | ISO 1924/1 |
| Tear strength MD | cN | >1100 | >900 | ISO 1974 |
| Tear strength CD | cN | >1200 | >1000 | ISO 1974 |
| BENDTSEN | ml/min | <100 | <500 | ISO/DP 8791-2 |
| smoothness FS | | | | |
| BENDTSEN | ml/min | <500 | <700 | ISO/DP 8791-2 |
| smoothness RS | | | | |
| CIE whiteness | % | >85 | >80 | SCAN P 66 |
| D65/10° | | | | |
| Brightness 75° | % | 15-25 | 10-30 | TAPPI 480 |

A paper complex that meets these requirements can be obtained from a combination between, or of, MG Bleached Kraft, TF 8067 and CBE MG NOB WS paper.

For the case of the example corresponding to a strip 100 like the one in FIG. 3a, the preferred geometric specifications are the following:

TABLE 3
Geometric specifications of a label, example of
implementation of a variant of the invention,
which corresponds to that of a hanging label.

| | | Preferred | Wide |
|---|---|---|---|
| Dimension | Unit | range | range |
| Label length | mm | 99-160 | 80-180 |
| Main portion length | mm | 45-140 | 40-160 |
| Main portion width | mm | 38-47 | 35-50 |
| Extension width (a) | mm | 8-12 | 6-14 |
| Cut or slit length (l) | mm | 10-30 | 5-40 |

It should be noted that in order to accommodate possible deviations that may occur when transversely cutting the strip 100 to separate a label 10 or in order to accommodate possible deviations when positioning the label or the accessory element used in the stapling operation, the cut or slit 6 extends along the joining area A of the label and also, by a smaller length, through the main portion 2′ of the label 10′ that follows it on the strip.

For the case of the example corresponding to a strip 101 like the one in FIG. 4a, the preferred geometric specifications are the following:

TABLE 4
Geometric specifications of another label, example of implementation
of a variant of the invention, which corresponds to that of a label
joined by two opposite ends to respective closed portions of a bag.

| | | Preferred | Wide |
|---|---|---|---|
| Dimension | Unit | range | range |
| Label length | mm | 160-320 | 140-340 |
| Main portion length | mm | 100-260 | 80-280 |
| Main portion width | mm | 40-98 | 35-105 |
| Extension width (a) | mm | 8-12 | 6-14 |
| Cut or slit length (L) | mm | 20-40 | 15-45 |

It should be noted that, similarly to the previous case, in order to accommodate possible deviations that may occur when transversely cutting the strip 101 to separate a label 11 or in order to accommodate possible deviations when positioning the label or the accessory element used in the stapling operation, the cuts or slits 6, 6′ made in adjacent joining areas A, A′ on the strip 101 are continuous sections of one same common cut or slit which midpoint is, in the example, equidistant to the two main portions 2, 2′ of the adjacent labels 11 and 11′, consequently the cuts or slits 6 and 6′ are of equal length.

Although the cuts or slits 6, 6′ have been shown in the drawings in a continuous manner, the invention provides for some variants.

Thus, for example, the cuts or slits 6 made in the joining areas A on each label 10, 11 can pass through the thickness of the strips, either along the entire length of the cut or slit 6 or in at least one section of the same. Likewise, the cuts or slits 6 are intended to be continuous or intermittent. Likewise, an cut or slit 6 is intended to combine at least one through area, which passes through the thickness of the strip, with at least one non-through area, which does not pass through the thickness of the strip but marks a preferential fold line. Likewise, not all the cuts or slits 6 made in one same strip are intended to be the same, being able to alternate cuts of different configurations in one same strip. Likewise, the cuts or slits are not intended to be straight, being able to follow a waved path, as a non-limiting example, avoiding zigzag or crenelated paths with breaks that can be starting points for tearing. Likewise, the cuts or slits 6 are intended to have a closed contour, forming a type of narrow window, or a succession of small windows, which empties material from the corresponding joining area.

1. A roll-up strip of labels, which contour follows a repetitive pattern which defines a linear succession of labels that can be separated by a transverse cut of the strip, the labels being especially suitable for application on bags of fruit and vegetable products, such as mesh bags, distinguishing for this purpose on each label, longitudinally
a main portion, bearing information printed or otherwise transferred to the strip on at least one of its faces, and from at least one of the opposite longitudinal ends of which it extends;
a longitudinal extension of a smaller width than that of the main portion and which distal end defines a joining area that is intended to be used to attach the label to a previously tightened portion of a bag and to be secured to the same by external application of an accessory pressing element, in a bag closing operation,
wherein
a longitudinal cut or slit is made in the strip in each joining area of the labels, the purpose of which is to reduce the resistance offered by the said joining area to a deformation by transverse constriction to which it will be subject when the accessory pressing element is applied to it from the outside in the bag closing operation.

2. The strip according to claim 1, wherein the strip is devoid of any reinforcement or filler made of plastic material.

3. The strip according to claim 1, wherein the strip is a paper strip, which is selected from
a paper substrate with a grammage of 80-160 g/m²; and a thickness of 100-185 μm; or
a paper complex with a grammage of 100-200 g/m²; and a thickness of 110-210 μm.

4. The strip according to claim 1, wherein the paper is a thermal paper.

5. The strip according to claim 1, characterised in that wherein the width (a) of the strip in the joining areas is from 6 to 14 mm, preferably from 8 to 12 mm; and this width (a) does not represent any widening of the associated longitudinal extension.

6. The strip according to claim 1, wherein all the joining areas have parallel edges and a constant width (a).

7. The strip according to claim 1, wherein the longitudinal cut or slit defines two equal halves in the associated joining area.

8. The strip according to claim 1, wherein the cut or slit made in the associated joining area passes through the thickness of the strip.

9. The strip according to claim 1, wherein the cut or slit is a continuous cut or slit.

10. The strip according to claim 1, wherein the cut or slit is a discontinuous or intermittent cut or slit.

11. The strip according to claim 1, wherein the cut or slit combines at least one through area, which passes through the thickness of the strip, with at least one non-through area, which does not pass through the thickness of the strip but marks a preferential fold line.

12. The strip according to claim 1, wherein a respective longitudinal extension of a smaller width than that of the main portion extends from each of the two longitudinally opposite ends of the main portion of each label, each with a corresponding distal end, that defines a joining area, two consecutive labels of the strip being joined without a solution of continuity by respective joining areas, each longitudinal cut or slit being associated with a section of a common cut or slit that extends along the said two following joining areas of the strip.

13. The strip according to claim 1, wherein the length of the common longitudinal cut or slit that extends along two following joining areas of the strip is from 15 to 45 mm, preferably from 20 to 40 mm.

14. The strip according to claim 1, wherein only one of the two longitudinally opposite ends of the main portion of each label extends a longitudinal extension of a smaller width than that of the said main portion, two consecutive labels of the strip being joined without a solution of continuity by the connection between the joining area of a label and the end of the main portion devoid of extension of the label that follows it on the strip, the longitudinal cut or slit extending along the joining area and also, by a smaller length, through the main portion of the label that follows it on the strip.

15. The strip according to claim 1, wherein the length of the longitudinal cut or slit that extends along the joining area and that extends through the main portion of the label that follows it on the strip is from 5 to 40 mm, preferably from 10 to 30 mm, remaining within the joining area by at least 80%.

16. A label that can be obtained by a transverse cut of a strip according to claim 1 coinciding with at least a joining area thereof, which joining area or areas now the end or ends of the label is subdivided into two longitudinal portions that hang like a fringe from the end of the associated extension.

17. A mesh bag with a tightened end and closed by application of an accessory pressing element with interposition of a joining area of a label that can be obtained from a strip according to claim 1, placed so that the longitudinal extension of the main portion of the label extends coinciding with the longitudinal direction of the bag, embracing the joining area of the label at least partially to the mass of tightened mesh with the two portions of said joining area folded around the cut or slit made in this area of the label.
